(19) United States
(12) Patent Application Publication
(10) Pub. No.: US 2006/0136824 A1
(43) Pub. Date: Jun. 22, 2006

(54) Process official and business documents in several languages for different national institutions

(76) Inventor: Bo-In Lin, Los Altos Hills, CA (US)

Correspondence Address: Bo-In Lin, 13445 Mandoli Drive, Los Altos Hills, CA, 94022, US

(21) Appl. No.: 11/272,605

(22) Filed: Nov. 14, 2005

Related U.S. Application Data
(60) Provisional application No. 60/627,427, filed on Nov. 12, 2004.

(51) Int. Cl. G06F 17/24; G06F 17/21

(52) U.S. Cl. 715/531

(57) ABSTRACT

An improved method and document management configuration to allow a person to conveniently control a sentence structure by easily shuffling different phrases in a sentence such that better, faster, and more accurate document translations can be accomplished among a team of patent attorneys/agents in working together to draft a patent applications into at least two different languages. A novel document processing and translating program is provided to first process the document to select few sentences each with a representative sentence structure. A manual input is allowed for each of these sentences a “standard” translation with a correspondent “standard” sentence structure in a second language. These correspondent standard sentence structures in the second language will then be applied as a reference for translation to improve the quality of the translation.

This application is a Formal Application and claims priority to pending U.S. patent application entitled “PATENT APPLICATION READY FOR FILING IN SEVERAL NATIONS DRAFTED BY A MULTIPLE LINGUAL ATTORNEY TEAM” filed on Nov. 12, 2004 and accorded Ser. No. 60/627,427 by the same Applicant of this Application, the benefit of its filing date being hereby claimed under Title 35 of the United States Code.

### BACKGROUND OF THE INVENTION

1. Field of the Invention

This invention relates generally to a process for document preparations. More particularly, this invention is related to document process and management for filing, prosecuting, status tracking and maintenance of official and business document that is prepared in several languages for submission to either a governmental or authorized institutes or to business entities in different national states.

2. Description of the Prior Art

Conventional processes for preparing, processing, prosecuting, status-tracking and maintenance of business and official documents in different languages for review and process by either business or official authorities in different national states are complicated, costly and often difficult to manage. Under most circumstances, it is also difficult to monitor and keep track of the most up to date status of the process of such documents especially when several groups of people are involved in different nations dealing with a same document translated into different languages.

One specific example is the processes of prosecuting a patent application in several different nations. The conventional process of preparing a patent application started by one patent attorney drafts a patent application with a major purpose of submitting to a patent review and granting governmental institute for obtaining a patent in one nation. Then, for the purpose of filing into different nations, the original patent application written in a specific language is then translated into different languages and filed into different governmental institutes by different patent agencies in each nation. With respect to the translations and all the processes of filing and prosecutions, the original inventor or the assignee as the owner of the intellectual property has very little control or accountabilities. There are little knowledge or assurance that a foreign agent can provide a satisfactory translation quality or the full right of a patent owner is protected due to the reality that it is difficult to assure that a foreign patent agent can provide timely, diligent and effective efforts during the entire prosecution processes. The greatest difficulty is the gaps of communications developed through multiple languages and multiple layers of patent agencies and governmental institutions involved. Therefore, the conventional processes of preparing and prosecuting a patent application in different countries become complicated, lack of control and accountabilities, and very costly.

In addition to the above-mentioned difficulties, a common problem encountered in translating a document written in a foreign language is the differences in the sentence structures between two different languages in arranging the sequence of a plurality of phrases. In the process of translating a sentence, it is often required to rearrange the sequence of different phrases to reconstruct a sentence that would be sensible when translating into that sentence into a different language. There are software programs that can perform a very rough first draft translation by a word-by-word or phrase-by-phrase translation. However, even the words and phrases are all correctly translated, the translated document is still a translation of a poor quality due to the awkward sentence structure. For a more efficient team effort in writing a patent application, it is required to provide improved methods to enable a more effective tool to more correctly translating a document into a foreign language with more personal control.

Additional difficulties of managing and processing documents translating into different languages are the lack of practical tools and methods to review and check the quality of the translation with a more systematic and quantifiable methodology. Due to the language barrier, unless a document reviewer has comprehensive understanding of both languages, it is difficult for a person without the language skill to check and has some assurance of the quality of the translated document. However, such quality check is often critically important for accurate use of terms and for consistency of term translation in the whole document, particularly for documents such as translation of patent claims and also contract that involve important legal rights of parties signing the contracts in different languages.

Therefore, a need still exists in the art of multi-national document process and management to provide methods and tools to overcome such difficulties and limitations.

### SUMMARY OF THE PRESENT INVENTION

It is therefore an aspect of the present invention to provide a novel team approach to handle and manage the tasks of multiple lingual multiple-national document preparation and prosecutions. One specific example is to apply such team approach to the tasks of multiple lingual multiple-national patent application preparations and prosecutions.

Specifically, in a preferred embodiment, a team of patent attorneys each familiar and experienced in preparation and prosecution of patent applications in different nations are formed. A team leader is assigned to lead the drafting and preparation of a patent application for a nation of primary importance to a patent applicant, e.g., an inventor, or a patent owner such as a patent assignee. The draft is reviewed and discussed among the team members such that each patent attorney or agents understand and become familiar with the invention and the scopes of claims and prosecution strategies of the patent application. In the process of completing the completion of the patent application for submitting to the nation of primary importance, e.g., United States of America, the patent application may be simultaneously reviewed, translated or revised by each patent attorney or agent into different languages and arranged into suitable forms for submitting into different patent office for application in different nations.

Furthermore, there is a need to improve the processes for preparing and prosecuting the multi-national patent applications to provide a system and method that can integrate the tasks performed by patent attorneys from different nations using different languages governed by different legal systems to work as a team to generate a coherent high quality patent application. Meanwhile, it is desirable that this team of attorneys involved in preparation and prosecutions of the patent applications filed into multiple nations can continue to function as an integrated team managed and monitored by a single timetable to respond to office actions from different nations and reporting to the clients with an integrated status and schedule to reduce complexities of case managements and costs.

It is another aspect of this invention to implement a team approach to prepare and prosecute a patent application filed into different nations by maintaining an integrated database for monitoring and updating important actions and associated deadlines required to prosecute the patent application in different nations. The inventors and patent application assignee are provided with integrated overall schedule to review and comprehend the most up to date progress of the prosecution status of the patent applications filed into different nations. Cost savings are also achieved without multiple layers of communications and managements.

It is a further aspect to provide an improved method and document management configuration to allow a person to conveniently control a sentence structure by easily shuffle different phrases in a sentence such that better, faster, and more accurate document translations can be accomplished among a team of patent attorneys/agents in working together to draft a patent applications into at least two different languages. A novel document processing and translating program is provided to first process the document to select few sentences each with a representative sentence structure. A manual input is allowed for each of these sentences a “standard” translation with a correspondent “standard” sentence structure in a second language. These correspondent standard sentence structures in the second language will then be applied as a reference for translation to improve the quality of the translation.

Briefly, in a preferred embodiment, the present invention discloses a process for preparing a patent application. The process includes steps of a) organizing a patent preparation and prosecution team comprising patent attorneys/agents for preparing the patent application in at least two national languages; and b) preparing and revising the patent application by the team in the national languages whereby the patent application is ready to file in two nations written in the at least two national languages. In another embodiment, the process further includes a step of c) filing the patent application written in the at least two national languages into at least two nations corresponding to the at least two national languages. In another embodiment, the process further includes a step of d) setting up a database for keeping tack of a prosecution status of the patent application in the at least two nations. In another embodiment, the process further includes a step of e) processing and responding to an office action issued by a national authority in examining and issuing a patent for the patent application from each of the at least two nations by the patent preparation and prosecution team. In another embodiment, the process further includes a step of f) interfacing and communicating with an inventor or a patent application assignee about the patent application filed in the at least two nations through the patent preparation and prosecution team. In another embodiment, the process further includes a step of g) setting up network accessible database providing a status of the patent application in the at least two national languages to allow an inventor or a patent application assignee to login and monitor the status of the patent application filed in the at least two nations. In another embodiment, the step of setting up network accessible database providing a status of the patent application in the at least two national languages further comprising a step of setting up an Internet Website to allow an inventor or a patent application assignee to login for accessing the database for monitoring the status of the patent application filed in the at least two nations.

In summary a method for generating a document of at least two national languages conforming to at least two sets of rules is disclosed. The method includes a step of organizing a team of at least two persons each knowing at least one of said sets of rules and at least one of said national languages whereby said at least two persons can work together for generating said document. In a preferred embodiment, said at least two persons are two patent attorneys for generating a patent application in the two national languages each conforming to one of said two sets of rules of a patent application in one of said two national languages.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIG. 1 is an Internet system includes personal computers, provided with a database containing a document in two languages linked together for processing by a team of patent attorney to prepare a patent application in at least two national languages for filing in at least two national patent offices.

FIG. 2 is a flow chart for showing the processing steps carried out by a team of patent attorneys/agents to prepare and prosecute a patent application in at least two nations in two different national languages.

FIG. 3 is a flowchart for showing the translation process to assure high quality and completeness of translation from a first language to various different languages.

FIG. 4 shows the numeral assignments of parsed phrase segments for an English translation of a long sentence written originally in Chinese for showing a convenience method to allow rearrangement of parsed phrases to obtain a best translation.

FIG. 5 shows the item-by-item identification and comparisons for all nouns and verbs to assure the completeness of the translation from one language to another and to enhance the quality check of the accuracy of the translations.

FIG. 6 is a flowchart to illustrate the processing steps for improving and audit the quality of a translation.

FIG. 7 shows display image of a user interface of a revision and reediting environment to allow a user to graphically parse and combine a sentence during a revision and reediting process.

FIG. 8 shows another display image of a user interface of multiple working environments each based on a working engine to carry out different document processing and management tasks.

### DETAILED DESCRIPTION OF THE PREFERRED EMBODIMENT

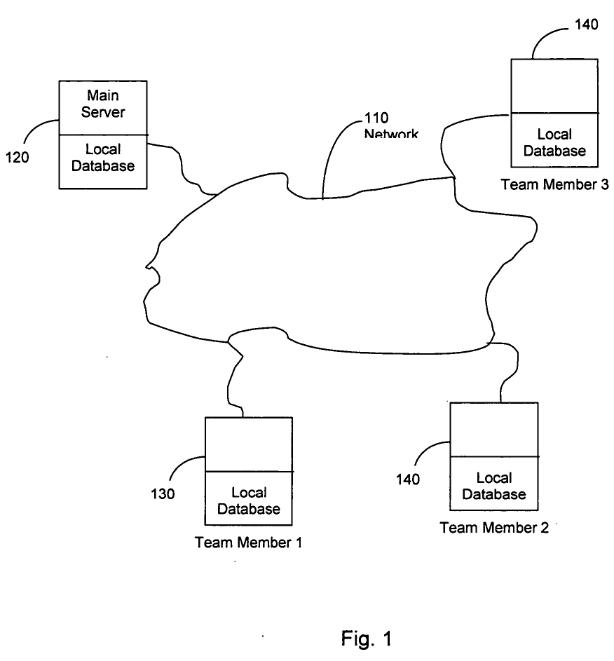

Referring to FIG. 1 for a system 100 that includes a network 110 for linking a team of patent attorneys/agents, i.e., team members 130, 140 and 150. Each team member has a specialized national patent legal system and language. These team members are connected by the network 110 to access a main server 120 that includes a database for storing patent application and prosecution documents. The database further includes a status table to provide detail prosecution history and status of the patent application or issued patents in different national patent offices.

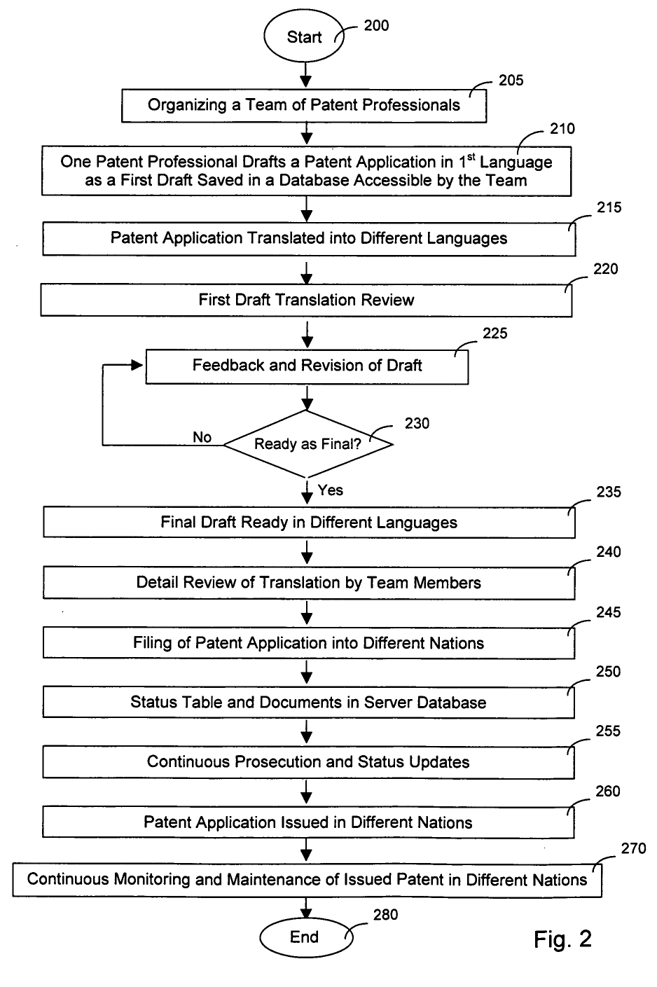

Referring to FIG. 2 for a flowchart of the process for the multi-national patent Application preparation and prosecution team to prepare and prosecute a patent application before the patent office in multiple nations in multiple languages. The process starts (step 200) with the formation of a multi-national patent application preparation and prosecution team that includes patent attorneys or agents of multiple nations familiar with the legal systems (step 205). A patent attorney or agent in a primary application nation, e.g. the nation of the inventor, first write a draft of the patent application in a first language according to the legal requirements and rules and regulations of the primary nation (step 210). In the meantime, the draft of the patent application written in the primary language is translated into different languages as a first translated draft (step 215) and reviewed by the team members of the multi-national patent preparation and prosecution team (step 220). Comments and suggestions are sent to the patent attorney or agent responsible for the primary patent application for modifications and corrections if necessary (step 225). A final version is generated after all the team members are satisfied with a final draft of the patent application (steps 230 and 235). Different team members in each of the multi-national languages then perform a detail review and revision of the translation of the application in each of the multi-national languages (step 240). The translated patent application is then submitted by the team members into different nations according to the rules and regulations in different nations (step 245). A status table and all the copy of different translations of the patent applications are available in a database of a main server that can be conveniently accessed by each team members of the multi-national patent preparation and prosecution team (step 250). Continuous prosecution processes are carried out in each different nations with the prosecution status and amendment documents available for review and reference by each of the team members of the multi-national patent preparation and prosecution team (step 255) until the issuance of the patent application (step 260). The issued patents are continuously monitored and maintained after the patent applications are issued in different nations (step 270) by the multi-national patent preparation and prosecution team and the process ends (step 280).

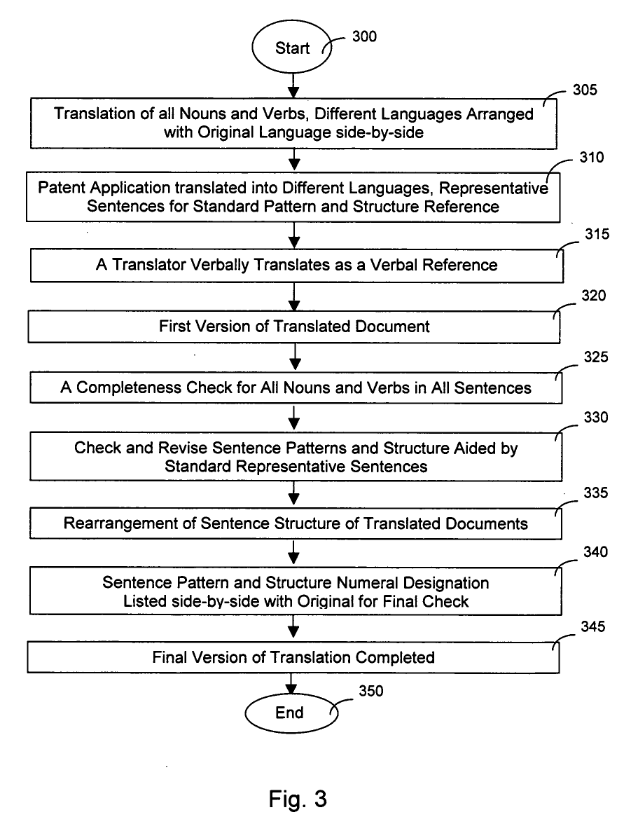

Referring to the flowchart shown in FIG. 3 for the processing steps carried out to assure high quality and accurate translation of the patent application into different languages. The translation process starts (step 300) with a keyword translation process where all the nouns and verbs in each sentence of a first language is translated into a second language and listed immediately next to the sentence for translation (step 305). The translation-processing program further selects few standard sentences that are representative of the sentence patterns and structures in the original language of the patent application (step 310). Based on these keywords placed immediately next to relevant sentences, and the selected sentences as representative sentence patterns and structures, a translator first verbally speaks and inputs translated sentences according to a first glance reflection after quickly review each sentence (step 315). Based on the sentence structure and essential meaning according to the verbal input, a first version of the translation is generated (step 320). The first version of the translation includes highlighted nouns and verbs side by side with the original version such that a “complete” check can be easily performed to assure all the nouns and verbs in each sentence are translated and included in the translation (step 325). Then a translation reviewer reviews each sentence to assure proper sentence patterns and structures are used. A convenient process is provided for the reviewer to selected a pattern and structure number designated for each of the standard pattern and structure for each of the selected sentences representative of different patterns and structures (step 330). Based on these pattern and structure number selected, each sentence can be rearranged to generate a smooth and high quality translation most appropriate according to the special ways of expressions of a particular language (step 335). A sentence pattern and structure number is designated for each sentence along with the highlighted nouns and verbs list side by side with the original language for a final quality review and revision (step 340) such that a high quality well checked and properly arranged translation is produced (step 345) when this translation process ends (step 350).

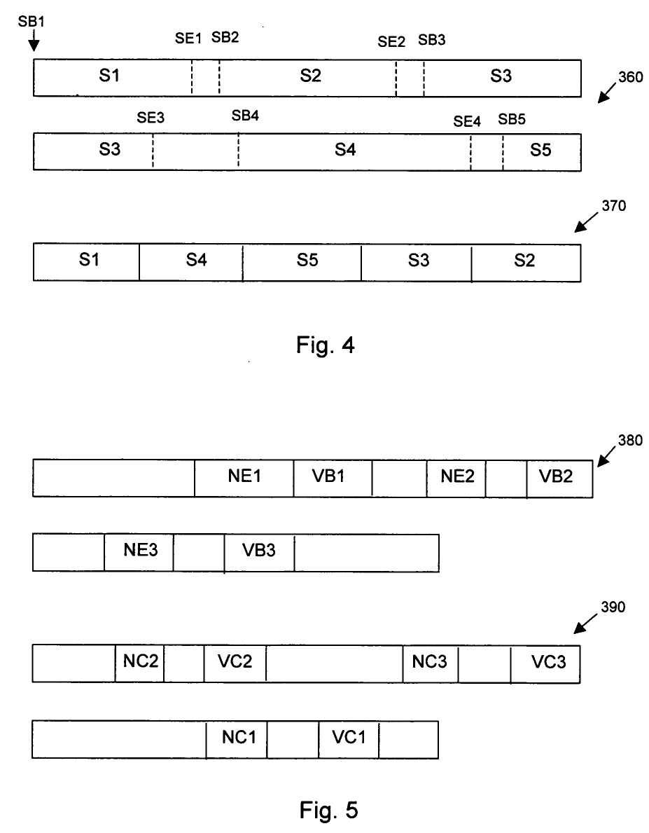

Referring to FIG. 4 for a diagram for showing a parsed sentence that provides a convenient way of rearranging a translated sentence. Specifically, a translated sentence is parsed into several segments with each segment designated with a segment number, e.g., S-1, S-2, S-3, etc. Each segment has a segment beginning pointer and an ending pointer, e.g., SB-1, SE-1 for segment 1. Each of these beginning and end pointer can be easily dragged and dropped to different points of a sentence to rearrange the segment. It is understood that there are different “transitional” word or phrase between the beginnings of subsequent segment, e.g., SB3, and the ending of a proceeding segment, e.g., SE2. A rearrangement of segments can be easily achieved by entering into a rearranging box the segment number in rearranged sequence, e.g., S-1, S-4, S2, S-3 to rearrange the segment according to a new sequential order.

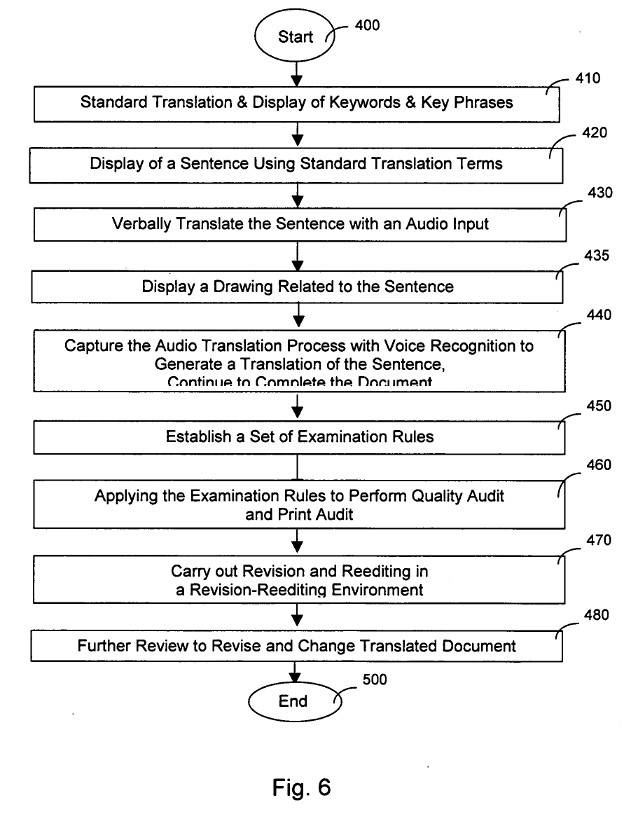

Referring to FIG. 5 is a diagram for showing a sentence in a first and second languages wherein each noun, e.g., NE1, NE-2, NE-3, in English and NC-1, NC-2, NC-3 in Chinese etc., and verb, e.g., VE1, VE-2, VE-3 in English and VC-1, VC-2, and VC-3 in Chinese, are high lighted side-by-side. A reviewer can conveniently compare and check the completeness and accuracy of the translation of each nouns and verbs. A reviewer can easily correct or add necessary nouns and verbs to complete and correct the terms of the translation before more detail checks on sentence structures and patterns are carried out as that shown in FIGS. 3 and 4.

As the display technologies and visual and audit technologies are making tremendous advancements, visual display and audio output may be used to enhance the translation and translation review and audit processes. A two or three panel displays may be placed side-by-side to display simultaneously document in different languages with different colors to show corresponding portions of documents in translated into different languages. The side-by-side display that shows different sentence structure in the translation document may be changed with a verbal input from a translator of translator quality reviewer. A voice recognition program is employed to recognize the audio input and the translation program is provided with commands and application capabilities to use the input data received form the voice recognition program to change the translation terms, sentence structure, or document arrangement according to a user input. Audio and visual display technology my be employed to set up more convenient and effective user interface to allow a translator to quickly and effectively translate, review, revise and rearrange the translation of a document by displaying side-by-side different versions and languages of a same document.

In order to assure high quality translation of a document from the original language to a different language, the multi-language document management system of this invention further provide a translation quality audit. The audit process generates different kinds of audit reports to present the results of translation quality audit. Applying different kinds of rules, an audit process can generate a translation quality audit report with a score based on how complete the translation document is in compliance with different kinds of rules. A translation quality auditor may input these rules. Examples of these rules may include how complete the translation is when compared to the original document by requiring every important noun and verb of the original document are completely translated and included in the translated document. These important nouns and verbs may be inputted by the translation quality auditor or generated by the document process program based on the number of times these important nouns of verbs appear in the original document.

Another rule may be the rule of consistence of translation that requires the consistent translation of an important term be consistently translated in the whole document. These important terms may be inputted by a translation quality auditor or may be generated by the document-processing program by counting the number of times these terms appear in the original document. Another set of rules may be related to smoothness and readability of translation. A translation quality auditor is enabled to select few typical sentences from the original documents by providing “reference” or “standard” translation of these typical sentences with pattern and sentence structural designations. These pattern and sentence structural designations are then applied for comparing the remainder of the translation document to determine the readability of the translation document. A readability score is then generated. A list of sentences with high score readability and low score of readability are listed for further review, examination and corrections. A set of grammatical rules may also be applied for reviewing the sentence structural of each sentences of the translation document to generate a readability score based on compliance with the grammatical rules.

Different audit reports may be generated. A first quality audit report may include a table of multiple columns with a first column lists all the nouns and all the verbs, the second column lists the paragraph and line number of each of these nouns and verbs in the original document. The third line list the translation of each noun and verb and the fourth line list the paragraph and line number of each noun and verb in the translated document. This table thus provides a convenient and easily searchable tool for a reviewer to assure all the nouns and verbs are translated such that there is no missing terms in the translated document. The table also provides a convenient way to assure that the translation of the nouns and verbs are consistent between different sections of the translation document. In order to generate more meaningful audit report, the multiple language document process and management system further provides a user interface to allow a user to input a list of important nouns and verbs.

A certification of quality audit may be inputted to certify allowing a quality auditor to enter a signature to certify the quality of the translation document performs a translation quality audit. Such certification if necessary may be applied to evidence the legitimacy of a document.

Since the quality of a translation document into different languages may also involve the laws in different countries and the histories of the process of the document in different nations. For example, translation of patent document into a second language may be necessary to refer to the prosecution histories of the original patent application in the mother country or the prosecution histories in different nations. The translation processing programs may provide a link to such document or even alert the translator to refer to such reference document during the process of translation to further enhance the document process for translating and process a patent application in the nation intended by the translated patent application documents. Such link and references may also be applied for linking to special laws and regulations for translating documents of investment contract in a nation where special laws and regulations govern such activities such that the effects of the translation document may be properly established according to the rules or regulations in different nations. A working environment is provided for a translator to link to most up to date database, document archives, design or operational drawings or procedures, specifications such that the quality of the translated documents may be enhanced. Alert of special notice may be implemented as “pop up” alert such that a document translators of legal, official or business documents are made aware of important references during the processes of document translations.

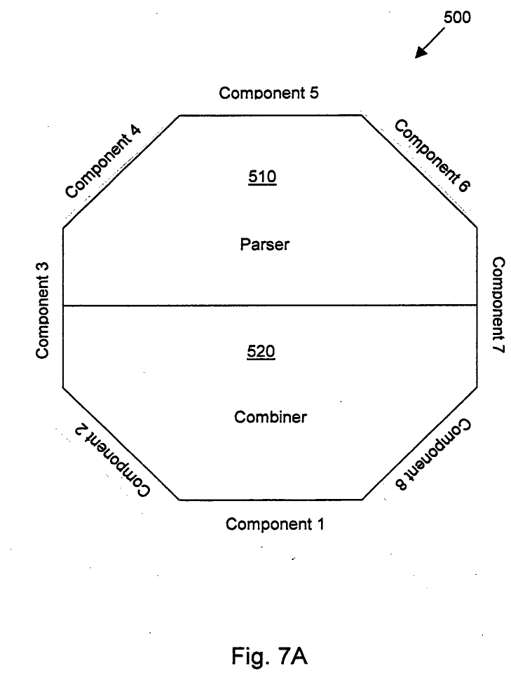

Referring to FIG. 6 for a flowchart lists the processing steps for effectively translating a document with high degree of readability and accuracy. The process begins (step 400) with a process of providing a list of standard translation for keywords and key-phrases for a document (step 410). According to these standard translations of key terms and key phrases, a display system is then employed to display a sentence on a display device in the original language and an audio system is employed to first read the sentence in the original language (step 420). Looking at the sentence and listening to the audio output, a person who is highly trained in instantaneous translation is allowed with a certain length of time to verbally translate the sentence (step 430). The verbally translated sentence is captured with a voice recognized processor to generate a first version of the translate sentence. The translation as captured and the voice-recognized by the voice recognition processor is also displayed such that the verbal translator can review the translation immediately. The processes proceed until the entire document is completed (step 440). Application of verbal translation aided by the visual display has the benefits of increasing readability and the process has a very high processing speed. In addition to showing the original sentences and the translated sentences to the verbal translator, further display of related figures and drawings as that described in a selected portion of the text under translation (step 435) may also be shown to help the verbal translator to better understand the portions of text under translation. Better understanding of the contents of a document often leads to better translation.

After the first version of translation is completed, a set of examination rules are established (step 450) to carry out examinations of the translation to perform a quality audit of the translated document. The examination rules may include a rule of completeness of translation to check if every nouns and verbs in all the sentences of the original document are translated. The examination rule may also include a rule of consistence to check if all the keywords and key terms are consistently translated. The rules may also include different grammatical rules to check if the grammar of the translated document has grammatical errors. After the quality audit check is performed, a quality audit report and score is printed out (step 460). The report lists all the errors and inconsistencies found in the quality audit. A score is calculated based on a set of scoring rules to quantify the quality of the translation. The score may be divided into a list of separate scores to quantify different types of qualities generated from different types of quality audit checks.

After the quality audit is completed, a document revision and editing process is carried out in a special revision and reediting environment is performed (step 470). The revision and reediting process is performed to correct errors or problems found in the translation audit and additional changes after a detail review (step 480) before the process is completed (step 490).

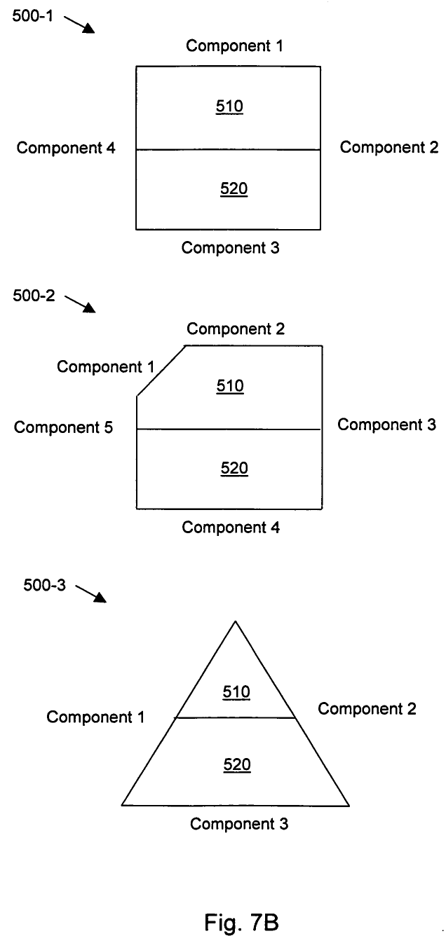

Referring to FIG. 7A for an exemplary revision and reediting environment 500 of this invention. The revision and reediting environment 500 is shown through a graphic user interface (GUI) as a polygon space having multiple sides with each side defined by a boundary line. In one embodiment, the revision and reediting environment 500 is separate into a parser environment 510 and a combiner environment 520. By using the graphic user interface (GUI) as displayed on a computer screen, a user can drag a sentence from a translated document 505 and drop the sentence into the parser environment 510. Once it is dropped into the parser environment 510, a parsing process is carried out to parse the sentence into different components and graphically placing each component on different sides of the polygon. The shape of the polygon may be changed depending on the number of components of each sentence. Then the user can drag these components now placed on different sides of the polygon 500 and drop the components each according to a specific order into the combiner environment 520. A restructured sentence is constructed by a combining process carried out by the combiner environment 520 that rearrange the sentence according to the sequence these components are dragged and dropped into the combiner environment. The revision and reediting environment 500 may have several levels, e.g., 500-1, 500-2, and 500-3 as that shown in FIG. 7B. In the revision and reediting environment 500-1 the parsing and combining operation is applied to parse and combine compound sentences when a long sentence includes multiple compound sentences. The components parsed by the parsing environment 510 include compound sentences. The lower level of revision and reediting environments 500-2 and 500-3 are applied to parse and combine shorter or less complicate sentences. For example, the revision and reediting environment 500-3 may be applied to parse and combine simple sentences. A user has the flexibility to apply different levels of revision and reediting environments to parse and combine sentences to graphically and conveniently carries out the revision and reediting tasks.

For a person of ordinary skill, it is understood that the application of polygon of different shapes are only to graphically display the parsed and combined components to enhance the user interface and convenience of revision and reediting. Any type and shape of graphic display to provide convenient and intuitive user operation visually in carrying out the revision and reediting processes may be included as part of this invention. Therefore, this invention discloses a document processing and management environment includes a user interface display for a user to carry out a document editing and management process by graphically manipulating document components displayed in said user interface display. In a specific embodiment, the document processing and management environment is a parsing environment for a user to place a sentence into the parsing environment to parse the sentence into several components. In another embodiment, the document processing and management environment is a combining environment for a user to place several components of a sentence into the combining environment to combine these components into a sentence. In another embodiment, the document processing and management environment is a reference environment for a user to place a portion of a document into the environment to link and display relevant reference information related to the portion of the document.

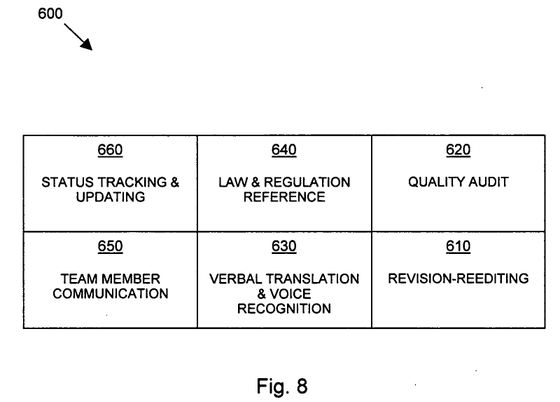

FIG. 8 shows an integrated working environment 600 to further integrate different aspects of translating, editing, processing and managing a document. The integrated working environment is carried out graphically through a graphic user interface (GUI) that are separated into different working environments such as revision and reediting environment 610, quality audit environment 620, verbal translation and voice recognition environment 630, law and regulation reference environment 640, team member communication and suggestion environment 650, and application and prosecution status tracking and updating environment 660, etc. Each of these working environments has an built-in environment engine to interactively and dynamically provide convenient and graphic “what you see is what you get” kind of task performances. For example, a law and regulation reference environment 640 provides automatic links to relevant websites through Internet connections to present updated laws and regulations when a particular section of document is processed, e.g., translated. The laws and regulations of a different nation is presented as reminder and reference for the translator during the process of translating a document, e.g., a patent application or a contract, into that particular nation. Therefore, the different document process environments constitute “document process and knowledge management environments” that include “environment engines and related database to provide user friendly working environments and convenient information links to carry out different aspects of document processes.

Therefore, this invention discloses different aspects of document processing and management. These documents may be in different languages for application and prosecution in multiple nations. A team approach with shared database to enhance communication and quality control of document process and management is disclosed. Methods and techniques for enhancing translation quality including visual display and parallel verbal translation with voice recognition processes are implemented. Translation quality examination rules are established to carry out quality audit with scores to quantify the quality of translation and document processes are provided. The results and scores of quality audit is included as part of the document history. This invention further discloses an integrated multiple working environments that includes several “document processing and management environments” presented with a graphic user interface based on a plurality document “processing engines”. These processing engines allow a user to apply drag and drop operations and other graphic element manipulation processes to carry out different document revision/reediting and other processes. In addition to the translation quality audit report, the quality of a translated document may further be certified by the audit report and a quality review performed by certified reviewer to certify and assure the quality of the document translation.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

I claim:

1. A process for preparing a document for translating into at least a second language comprising:
employing a computer program for comparing a translation document in said second language with said document for generating a translation audit report related to a quality of said translation document.

2. The process of claim 1 wherein:
said step of generating a translation audit report further comprising a step of generating a score representing said quality of said translation document.

3. The process of claim 1 wherein:
said step of generating a translation audit report further comprising a step of applying a set of rules for checking and generating a set of scores according to said set of rules representing said quality of said translation document.

4. The process of claim 1 wherein:
said step of generating a translation audit report further comprising a step of applying a rule of completeness of translation for checking and generating a score of translation completeness representing said quality of said translation document according to said rule of translation completeness.

5. The process of claim 1 wherein:
said step of generating a translation audit report further comprising a step of applying a rule of consistence of translation for checking and generating a score of translation consistence representing said quality of said translation document according to said rule of translation consistence.

6. The process of claim 1 wherein:
said step of generating a translation audit report further comprising a step of applying a rule of readability of translation for checking and generating a score of translation readability representing said quality of said translation document according to said rule of translation readability.

7. A process for preparing a patent application comprising:
organizing a patent preparation and prosecution team comprising patent attorneys/agents for preparing said patent application in at least two national languages; and
preparing and revising said patent application by said team in said national languages whereby said patent application is ready to file in two nations written in said at least two national languages.

8. The process of claim 7 further comprising:
filing said patent application written in said at least two national languages into at least two nations corresponding to said at least two national languages.

9. The process of claim 8 further comprising:
setting up a database for keeping tack of a prosecution status of said patent application in said at least two nations.

10. The process of claim 8 further comprising:
processing and responding to an office action issued by a national authority in examining and issuing a patent for said patent application from each of said at least two nations by said patent preparation and prosecution team.

11. The process of claim 8 further comprising:
interfacing and communicating with an inventor or a patent application assignee about said patent application filed in said at least two nations through said patent preparation and prosecution team.

12. The process of claim 8 further comprising:
setting up network accessible database providing a status of said patent application in said at least two national languages to allow an inventor or a patent application assignee to login and monitor said status of said patent application filed in said at least two nations.

14. The process of claim 12 further wherein:
said step of setting up network accessible database providing a status of said patent application in said at least two national languages further comprising a step of setting up an Internet Website to allow an inventor or a patent application assignee to login for accessing said database for monitoring said status of said patent application filed in said at least two nations.

15. A data file stored in a data handling system comprising:
a patent application having a first section written in a first national language for filing in a first national office designated for processing said patent application and a second section written in a second national language for filing in a second national office designated for processing said patent application.

16. The data file of claim 15 wherein:
at least one of said first and second sections comprising a translation of a different section.

17. The data file of claim 16 wherein:
said translation is linked to a translation database having a plurality of selectable sentence-structural arrangements available for a manual selection.

18. The data file of claim 16 wherein:
said data file is stored in said data handling system available for access by a team of patent attorneys is linked to a translation database having a plurality of selectable sentence-structural arrangements available for a manual selection.
